(19) United States
(12) Patent Application Publication
(10) Pub. No.: US 2003/0103879 A1
(43) Pub. Date: Jun. 5, 2003

(54) Tube reactor based on a laminate

(76) Inventors: Peter Jahn, Leverkusen (DE); Klaus Ochmann, Leverkusen (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/209,351

(22) Filed: Jul. 31, 2002

(30) Foreign Application Priority Data
Aug. 8, 2001 (DE) 10138970.1

(51) Int. Cl. B01J 8/06

(52) U.S. Cl. 422/211; 422/180; 422/222

(57) ABSTRACT

A tube reactor based on a laminate, at least comprising at least three structured layers and a covering layer on the top and on the underside of the laminate, in which each layer has openings which are arranged in adjacent longitudinal rows and are elongated transverse to the longitudinal rows, in which the openings of a layer intersect at least three openings of an adjacent layer and the sequence of intersecting openings forms a channel in the longitudinal direction or in the transverse direction of the layers.

The invention relates to a tube reactor in the form of a laminate comprising at least three structured layers, the outside layers of which are each covered by a covering layer, in which each structured layer has a plurality of openings arranged in a longitudinal row, which openings are elongated in a direction transverse to the longitudinal row, wherein openings in different layers intersect to form a channel through which flow can occur.

The present invention relates in particular to an economical process for producing a tube reactor having integrated mixing contours and to its use for reaction processes which are carried out over wide temperature ranges, from about −80° C. to about 500° C. and at pressure ranges of up about to 500 bar. The materials which flow through the reactor can have a viscosity up to about 100 Pa·s.

Reactors having smooth walls in the form of tubes for large mass flows in laboratory apparatuses, pilot plants and production plants are known. These tube reactors are also produced in double-walled designs for tasks were temperature control is needed, so that introduction and removal of heat is possible. When water-like substances are being used, turbulent flow generally prevails, so that heating/cooling of the starting materials is unproblematical. If viscous materials having a viscosity of greater than 0.5 Pa·s are conveyed through flow channels or tubes, the flow is usually laminar and the rate of heat transfer to the heated/cooled wall of the tube is relatively low, so that temperature control via the channel wall is difficult to achieve. To improve the rate of heat transfer, static mixers then have to be installed or inserted into the flow channels. This engineering measure (cf., for example, DE 4 236 039A1) improves heating/cooling in the flow region and slightly increases the heat transfer area. This engineering procedure is complicated and increases the capital costs of an industrial plant to a disproportionate degree if a reaction having a relatively long residence time is to be carried out isothermally. For this reason, such engineering solutions with a ratio of channel length to hydraulic diameter of the flow channel of L/D>20 are uneconomical when known static mixers are used, and are therefore seldom implemented in practice.

Apparatuses made up of sheets which have many small parallel channels and are placed on top of one another in packets in order to generate, for example, large heat transfer areas relative to the specific apparatus volume are known from microstructure technology (cf. Mikro-Struktursystem für Ingenieure, VCH Verlagsgesellschaft mbH; VDI-GVC, year book 1997, pages 102-116, VCH Verlagsgesellschaft mbH). The flow channels of the microstructure apparatuses or systems run transversely or longitudinally relative to the film thickness. The use of microstructure apparatuses is restricted to applications in which the materials present are fluid, water-like and have a very low viscosity. More viscous substances having a viscosity of, for example, >1 Pa·s result in extremely high pressure drops because of the small flow cross sections, so that this technique is not suitable for relatively high viscosity materials. The apparatuses have very small channel cross sections, typically up to about 100 μm, and are produced from thin layers or sheets into which open channels are cut so that the next sheet in a packet of sheets closes the open channel underneath it. The sheets are bonded together and are then additionally installed in a housing and joined by welding. The flow channels of the known microstructure apparatuses have a defined depth which is always less than the sheet thickness. The methods of producing microstructure apparatuses (cf., for example, VCH-Verlag: Mikro-systemtechnik für Ingenieure, Federal Republic of Germany 1993, pp. 261 to 272) are technically very complicated and have been developed specifically for microstructure engineering. The specific machining or etching processes for producing the structures make it possible to obtain only short channel lengths (up to 2 cm long), so that this apparatus technology is not suitable for reactions in which laminar flow occurs and the reaction times are relatively long. A further problem with microstructure channels is the risk of blockage by contaminants in the substances.

Also known are structured metal sheets which are produced by noncutting forming and are positioned over one another, welded or soldered and lead to honeycomb bodies (DE 19 825 018A1). These parallel channels produced by noncutting forming are preferably used as catalyst supports in exhaust gas/waste gas treatment.

Further known structures are heat exchangers (cf., for example, WO 97/21064) which are made up of a large number of perforated metal sheets and in which the holes are arranged behind one another and thus form flow channels transverse to the metal sheets. Flow occurs axially into and through the free flow cross sections of the holes, so that the apparatuses are suitable mainly for applications in which the materials have an extremely low viscosity (<50 mPa·s).

WO 98/55812 likewise discloses heat exchangers having many channels which are cut into a plate and which run in a meandering manner so that somewhat longer residence times are possible. The channels are produced in the plates using the abovementioned methods of microstructure technology. This type of heat exchanger is only suitable for very fluid substances and is unsuitable for a process in which there is little backmixing and which has relatively long residence times. There is no mass transfer and no mixing action between the channels.

For this reason, it is an object of the invention to provide a tube reactor for single-phase or multiphase systems having an endothermic or exothermic character and having long residence times, in which the materials are viscous or the viscosity increases during the reaction, which reactor continually mixes materials having a particularly high viscosity during flow through the reactor. The tube reactor should generate a mixing action during flow through it and have a large area which is contacted by the materials flowing through it, so that rapid heating/cooling is possible and mass transfer is promoted. The tube reactor should make emulsification and dispersion, for example, possible in a simple manner. Long reaction times require long tube reactors or flow channels, i.e. tube reactors having a large length/diameter ratio of, for example, greater than 20, with good heating/cooling being possible at the same time. The tube reactor should, in particular, have low backmixing so that reactions can be carried out with high selectivity. Furthermore, a single-channel principle is particularly desirable. The flow channels should be able to be produced simply and inexpensively. They should be capable of being scaled up from a laboratory scale with small flows in the region of typically a few ml/minute to larger scales for pilot plant or production operations with throughputs of a many litres/minute. The reactor should, if appropriate, be able to be formed of different materials for different applications, and should, in particular, be able to be produced in a variation that can serve as catalyst support or even be itself formed of a catalyst material. The tube reactor should be capable of operating over a wide temperature range of from about −80° C. to about 500° C., for example, and at high pressures, up to about 500 bar, for example. Furthermore, the reactor should be capable of carrying out endothermic and exothermic reactions, continuously and in miniaturized form of the reactor, and in combination with various other process engineering instruments and other apparatuses. Apparatuses which may be employed in combination with the tube reactor include vessels, pumps, known static mixers, particular emulsification and dispersion devices and measuring instruments required for automatic control and regulation of processes in which the reactor is used. To monitor the process, on-line analytical instruments may be adapted to follow the progress of the process and, if desired, to control it on the basis of the process information.

This object is achieved according to the invention by a tube reactor, based on a laminate, at least comprising at least three structured layers and a covering layer on the top and on the bottom of the structured laminate, in which each structured layer has a plurality of openings which are arranged in at least one longitudinal row and wherein the openings of a middle layer have at least three openings which intersect an adjacent layer so that a sequence of intersecting openings forms a flow channel in the longitudinal direction or transverse direction of the layers.

The openings of a layer can be produced in any way, e.g. by drilling, milling, etching or punching. Preferably the openings within a single layer have no connections between one another.

The reactor is based, for example, on individual thin laminae or layers which are structured by means of similar longitudinal openings, e.g. punched holes, which make an angle of 45° to the longitudinal row of openings, where the next layer or lamina above or below is turned through an angle of 180°. The covering layers close the uppermost and bottommost openings of the laminate. This forms a flow channel with internal contours which exerts a mixing action on the material flowing through it. The resulting large areas in contact with the product in the interior of the flow channel formed significantly improve mass transfer and heat transfer, and promotes plug flow characteristics with a narrow residence time distribution, especially when viscous liquids having viscosities of >1 Pa·s are passed through the channel, and low backmixing. Due to the simple and economical method by which the reactor can be manufactured, very long flow channels, in particular, can be achieved at relatively low cost. When multiphase mixtures of, for example, gaseous and/or liquid components are passed through the channels, the internal contours of the channels effect dispersion or emulsification and prevent separation of the phases. A particular advantage of the reactor is that it can be used for carrying out a variety of processes by adapting the thickness of the layers and the area of the openings to particular application areas, e.g. in micro, miniature and production engineering. For applications in microengineering, the laminate is preferably produced from thin sheets having a thickness of a few μm. In production engineering, use is made, in particular, of layers of metal sheets which have a thickness of several mm.

If the structured layers in a tube reactor are each provided with a plurality of rows of openings which form individual channels located next to one another, cross-connections between adjacent channels can be produced by intersection of adjacent openings of channels located next to one another. A pressure drop in the tube reactor can be reduced in this way.

The tube reactor having a laminar structure is preferably configured so that the openings in the structured layers are arranged in a periodically recurring fashion.

The shape of the openings can be chosen essentially freely. The openings preferably have the shape of ellipses, slits or rectangles and their depth corresponds to the thickness of the metal sheet or layer. The openings which preferably have an elongated geometric shape (e.g. slots, rectangles or flat ellipses) have their longitudinal axis (main direction of elongation) at an angle α of from 5° to 85°, particularly preferably from 30° to 60°, to the line formed by the row of openings which they are in, so that transverse flow of the material flowing through the channels formed by said openings is reinforced within an opening of a layer.

Preference is given to an embodiment of a reactor in which the openings in the structured layer are arranged in a nested row so that, when viewed in the longitudinal direction of the row of openings, adjacent openings are arranged next to one another over at least part of their length.

This means that in a cross section through the laminate perpendicular to the main direction of flow through the reactor, which corresponds to the longitudinal direction of the row of openings, at least two openings in a layer are visible next to one another.

In this way, mixing sections can be significantly shortened in the case of laminar flows and mass transfer and heat transfer can be increased and mixing can be generally improved.

The laminates can be produced, for example, by placing identically shaped or identically structured metal sheets on top of one another, with each sheet being turned by 180° relative to the longitudinal axis (longitudinal row of openings) compared to the sheet underneath it. This embodiment is possible when the longitudinal rows of openings are located directly above one another when the sheet is turned. The openings of the adjacent layers intersect, and there is an intersection ratio formed by the ratio of the cross section of the entire opening to the sum of the superposed part cross sections of the openings which is, in particular, from >1.5 to 10.

Preference is therefore given to a flow channel built up in layers wherein adjacent rows of openings in the structured layers have an intersection ratio of the openings of from >1.5 to 10, particularly preferably from 2.5 to 7.5, so that the material flowing horizontally relative to the plane of a layer is divided at the inner surfaces of the walls of the openings and is diverted into the openings of adjoining layers, and the divided streams flow along the webs between the openings and are mixed again in the subsequent openings and are then divided again.

The number of openings in a row of openings in a structured layer is preferably at least 50, particularly preferably at least 200, very particularly preferably at least 500.

A tube reactor composed of structured layers and having an optimum flow cross section is particularly advantageous when the L/D ratio of the length of the row of openings (L) to the hydraulic diameter (D) of the flow cross section is greater than 10, preferably greater than 100 and particularly preferably greater 500. The diameter D is related to a circular cross section and is connected with the width W and height H of the rectangular cross section according to:

$$D = \frac{\sqrt{4 B \cdot H}}{π}$$

This results in very long flow channels having a narrow residence time distribution in which the material flowing through is intensively mixed by the ribs projecting into the flow region. In such a reactor, it is possible to carry out endothermic or exothermic reactions of temperature-sensitive materials at a constant process temperature in the interior of the channel through which flow occurs. The reactor is particularly advantageously employed when the substances used have a relatively high viscosity (η>100 mPa·s) and the viscosity of the mixture in the reactor increases during the reaction.

An assembly of superposed structured metal sheets/laminae which are in contact with one another form a packet of layers having at least one flow channel. The tube reactor can, depending on the configuration and number of the layers, have variously shaped flow cross sections such as square or rectangular cross sections. For a heated/cooled isothermal reactor, a flat rectangular flow channel cross section having a large proportion of heatable/coolable wall is preferred. Preference is therefore given, in this case, to a flow channel cross section having a geometric ratio of width to height W/H of >1, more preferably a W/H ratio of >5 and particularly preferably a W/H ratio of >10.

Here, the width is the dimension of the channel in the plane of a layer. The height corresponds to the sum of the thickness of the single structured layers.

The outer contour of the openings in the layers is preferably a zig-zag shape or wavy to give a larger contact area with the material flowing through the channels and thus to improve mass transfer and temperature control.

A preferred construction of the laminar reactor is based on an assembled packet of structured layers which is inserted in an enclosing housing so that the housing is in contact with the outer layers of the packet of layers and forms the covering layers for these outer layers. When the fit or seal between the packet of layers and the inner surface of the surrounding housing is sufficient to close the uppermost and bottommost openings ot the packet, there will be no flow bypassing the channels in the packet. This makes it possible for a user in research and development to optimize a synthesis or a continuously operated process. Simple exchange of packets of layers having different structures in the housing makes it possible to optimize processes with respect to heating/cooling, residence time distribution, selectivity and pressure drop.

Preference is also given to a variant of the reactor comprising at least two laminates which each have at least three structured layers and are arranged in series, with the laminates being rotated relative to one another by an angle β of from 30 to 60°, relative to the planes of their layers.

In a particular embodiment of the tube reactor, it is possible to place a plurality of packets of layers having structured layers on top of one another to form a stack. Here, the adjoining packets of layers are separated from one another by a shared covering layer or plurality of covering layers.

This forms, for example, a total packet having a plurality of flow channels.

More interesting industrially, however, is an embodiment in which at least two packets of structured layers are superposed, with the front side of the first packet of layers being configured as the inlet to the flow channel. The reverse side of this packet of layers is closed. The covering layer which separates the first packet of layers from the adjoining second packet has an open region at the end of the row of openings which leads to the second packet, so that there is a connection to the channel of the second packet. The second packet of layers is closed at the same end as the first packet. A fluid can flow through the channel of the first packet, then pass through the open region of the separating layer into the channel of the second packet and flow through the channel of the second packet in the opposite direction to the flow in the first packet.

Further packets of layers can follow the second packet in the same way, with the open connection between adjoining packets of layers always alternating between front and reverse side of the total reactor. The last packet, i.e. the uppermost or bottommost packet, has an outlet at the front or on the reverse side. In this construction, the fluid flows through the packet of layers in a meandering fashion, i.e. in the longitudinal direction and opposite to the longitudinal direction in succession. This embodiment makes it possible to achieve compact and small heatable/coolable reaction apparatuses having large areas which are in contact with the product and can advantageously be used for mass transfer or quick heating/cooling.

For processes which require a high level of heating/cooling, particularly long flow channels built up in layers are useful. An alternative to the above-described construction is the use of relatively large metal plates as structured layers in which the rows of openings in the plate form loops. A plurality of structured metal plates are stacked on top of one another to form a packet as in the case of the structured individual laminae. Two straight parallel longitudinal rows of openings which have, for example, been cut into a metal plate are in each case connected to one another at their ends via a row of openings having a semicircular shape or forming a straight cross connection. Connecting at least three such plates produces, in the simplest case, a packet of layers in which each channel formed by opposite, offset openings is transversely connected at its end to an adjoining channel. The position of the inlet and the outlet of such a packet of plates can in principle be chosen freely depending on the geometry of the plates. In particular, a plurality of packets of metal plates can be connected to one another so as to allow flow between them, so that channels having a very large L/D ratio and a high heating/cooling capacity can be created. The structured individual metal sheets of the packets are, for example, soldered to one another to form closed flow channels which can be operated under high pressure, e.g. up to 500 bar.

The tube reactors of the invention can be connected directly to flat heating/cooling units on both sides of the covering layers. However, heating/cooling units can also be connected in a detachable manner. Heating/cooling of the tube reactor can be achieved using connected hollow bodies through which heat transfer fluids flow, by means of electrical heating devices or by attachment of Peltier elements for cooling or heating.

Reactors which are, as described above, made up of large-area metal plates or thin sheets can, in a preferred variant, be provided with branching or confluent channels. Thus, for example, a plurality of independent flow channels having identical or different flow cross sections are formed in a laminate by a plurality of rows of openings which at a branching point join a common collecting main flow channel which in turn has a larger flow cross section than the individual channels preceding it. This arrangement of channels in a laminate enables, for example, a plurality of streams to be heated/cooled independently of one another so that a reaction commences only when the heated/cooled substreams come together in the collecting main flow channel.

In a further preferred embodiment, the reactor has at least two flow channels having hydraulic diameters of identical or differing magnitudes which go over into a common reaction channel. This allows separate preheating/precooling of two materials which, after leaving the heating/cooling section, flow into a common reaction channel having a larger hydraulic channel cross section and react with one another there while being continually mixed. The different heating/cooling can be carried out using, in particular, Peltier elements which can simply be positioned at the desired points. It is likewise possible to divide a main flow channel into two channels at a branching point.

A further particular embodiment of the tube reactor has at least one opening for introduction of material and/or discharge of material in the upper and/or lower covering layer, so that, for example, a gaseous or liquid material can pass through the covering layer and be introduced into the flow channel of the reactor or so that reaction mixture can be discharged.

A particularly preferred embodiment of the tube reactor allows a liquid and/or gaseous material to be introduced along the flow channel of the laminate by use of a porous covering layer or configuring the covering layer as a permeable membrane.

The porous covering layer allows at least one material to be introduced continually into the tube reactor through which another material flows, so that the material flowing through the reactor reacts chemically with the introduced material in, for example, the interior of the packet of layers.

In this way, gaseous and/or liquid materials fed into the tube reactor are intensively mixed with or emulsified or dispersed in the main stream in the flow channel of the reactor immediately after passing through the porous covering layer, which leads to an improvement in mass transfer and to rapid reaction of the material introduced. This can increase the space-time yield and the selectivity of a synthesis. The covering layer can also, in particular, be a membrane which is permeable in only one direction for the material to be introduced or discharged. In a particularly preferred embodiment, the porous covering layers are present only in segments or subsections of the long flow channel built up in layers.

An economical method of producing the reactor is to solder together the structured layers of the reactor. In this embodiment, for example, thin sheets of solder matching the structured individual layers are produced, so that the structured metal sheet and the structured sheet of solder can be joined permanently by a soldering process. The soldering together of all contact surfaces of the structured layers and the covering layers leads to flow channels which can be operated at high pressure, up to 500 bar. The structured layers and the associated covering layers can be joined to one another so as to form a seal along their nonstructured longitudinal edge by, as an alternative, laser or electron beam welding.

The invention further provides for the use of the tube reactor for carrying out chemical reactions and for mass transfer engineering, in particular as column packing, in extraction and in thermal separation technology.

A variant of the tube reactor having a different geometric structure is also subject matter of the invention. This tube reactor is based on a laminate comprising at least two structured layers which are wound around a core tube or core rod, where each layer has many openings which are arranged in one or more longitudinal rows and are elongated, in particular transverse to the rows, and a covering layer which is arranged on the outer circumference of the laminate and in which the openings of a layer intersect with the openings of the adjoining layer, where the sequences of intersecting openings form channels in the longitudinal direction of the core tube or core rod.

If the structured layers having parallel rows of openings which are to be rolled up are extended at one end by a nonstructured region, this nonstructured region can form the covering layer of this reactor. The nonstructured region is then likewise wound in a spiral fashion around the reactor, so that the end of the layer is welded to itself along the longitudinal axis of the corresponding cylindrical core. The concentric spiral laminate is thus closed to the surroundings and is pressuretight.

Flow of material into the reactor having rolled layers occurs either at the end or can be via specific radial openings in the covering layer.

A reactor having rolled structured layers can perform various functions when the individual layer is divided up into various structured and nonstructured regions. Thus, a preferred reactor can have a heatable/coolable concentric mixing channel and an enclosing porous covering layer around which there is a concentric hollow space through which material may pass and a pressuretight outer wall surrounding the hollow space. This variant is produced by the abovementioned rolling-up technique.

If these segment-like structured layers are coated with solder at the expected contact areas, the layers which have been rolled up in a spiral can be soldered to one another to produce a pressuretight apparatus.

As an alternative, an approximately concentric tube reactor can be produced by means of a plurality of pairs of structured layers wound around the core rod/tube, particularly when the lateral edges of the pairs of layers are offset by an angle γ of from 0 to <180° on the circumference of the core rod and are wound together around the core rod.

The structured layers for the tube reactor having flat layers can be made of various metallic or nonmetallic materials. The thickness of the layers is, in particular, from about 10 μm to about 10 mm.

In particular, the layers are made of a material selected from the group consisting of metal, in particular aluminium or steel, plastic, glass or ceramic. It is also possible to utilize the structured layers as a catalyst support or to produce them directly from a catalyst material. Individual layers can also consist of different materials than other layers.

In the case of a reactor built up around a core rod or tube, metal or plastics are likewise possible materials. Particular preference is also given to a tube reactor having a core rod or tube which is characterized in that the layers are coated on the surfaces which come into contact with the materials for which the reactor is being used by a catalytically active material, e.g. rhodium, gold, silver or nickel, or are made entirely of such a catalyst material. Such a reactor is preferably used in reaction engineering or waste gas technology.

In particular cases, the reactors of the present invention can be combined with microstructure apparatuses or systems which are known in principle, with known static mixers and with other process engineering apparatuses.

The tube reactors of the invention can be used for carrying out heating/cooling tasks and for reactions carried out isothermally. They have the advantage that mass transfer and heat transfer on flow through the channels is significantly increased compared with a simple flow channel (smooth tube) because of the large areas which are in contact with product. In many chemical reactions, this leads to increased selectivity and a higher space-time yield. The tube reactor can be used even on a laboratory scale, particularly in a single-channel design, to intensify a process in screening tests. Economic aspects in respect of reaction kinetics of syntheses can be examined in a continuous process even on a miniaturized laboratory scale. Exothermic reactions having a long residence time, in particular, can be carried out isothermally since tube reactors having a very large L/D ratio can be manufactured highly economically. Scale-up from a laboratory application to a pilot plant or production scale is possible by enlarging the openings of the laminate and thus adapting to the larger flows. Furthermore, scale-up to production conditions can be achieved by keeping the geometry of the laminate constant and increasing the number of rows of openings in a layer. The flow channels of the laminate have little hold-up, so that the residence time spectrum is narrow, which is an advantage in applications in which temperature-sensitive materials are involved. For this reason, the preparation of polymers and biotechnological and pharmaceutical production processes are applications of the tube reactor. The webs in the flow region between the openings of a row in a layer, particularly those transverse to the main direction of flow, considerably reduce the empty volume of the flow channel, so that no thermal damage to the materials flowing through occurs. The channels can, as described above, be produced with a small or very large L/D ratio. Furthermore, the tube reactor can be used as miniaturized heat exchanger.

The large contact areas formed as a result of the laminar structure make it possible for the tube reactor to be used economically in mass transfer processes, for example thermal separation processes.

If the layers comprise a catalyst material or are coated with a catalyst, possible fields of application are extended to waste gas technology, for cleaning or decomposition of materials in waste gases, e.g. in the exhaust catalyst of a passenger car. Due to the simple laminar structure of the tube reactor, production-line manufacture of the individual layers by means of etching, lasers or punching is possible, which leads to considerable cost reductions. An engineering design which allows high pressure gradients is possible if appropriate layer thicknesses and spacings between openings are employed. If the structured layers and the covering layers are soldered to one another, an expensive pressure-resistant housing can be omitted, which reduces apparatus costs. A particular advantage compared with microstructure engineering is the insensitivity of the tube reactors to blockage, so that additional fine prefilters for fluids and gases can be omitted. The layer technique used for the tube reactors can be applied very simply to microsystem technology if very thin foils or films are used as layers, i.e. ones having a thickness of less than 200 μm.

Depending on the process engineering and chemical tasks to be performed, combinations of the reactor of the invention with upstream and/or downstream vessels, pumps, dispersing apparatuses and known static mixer systems are appropriate. These combinations include sensors and actuators required for the process and on-line analytical facilities for process control.

The invention is illustrated below by way of example with the aid of the figures, but these examples do not constitute a restriction of the invention.

In the figures:

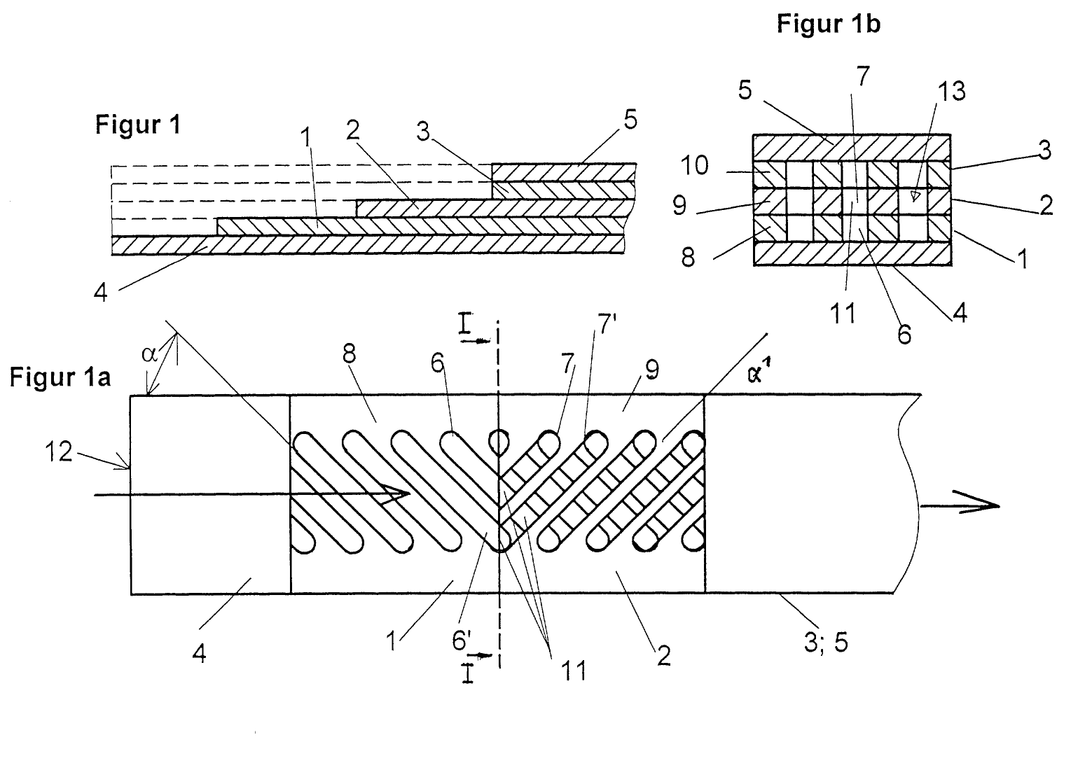

FIGS. 1, 1a, 1b show the structure of a tube reactor based on a laminate having three structured layers and an upper and lower covering layer. The structure of the tube reactor is shown in a cut-open depiction in FIG. 1a, so that the planes of the layers with the elongated openings and the intersecting regions of the openings can be seen. FIG. 1b depicts a cross section through FIG. 1a and shows the flow channel of the reactor.

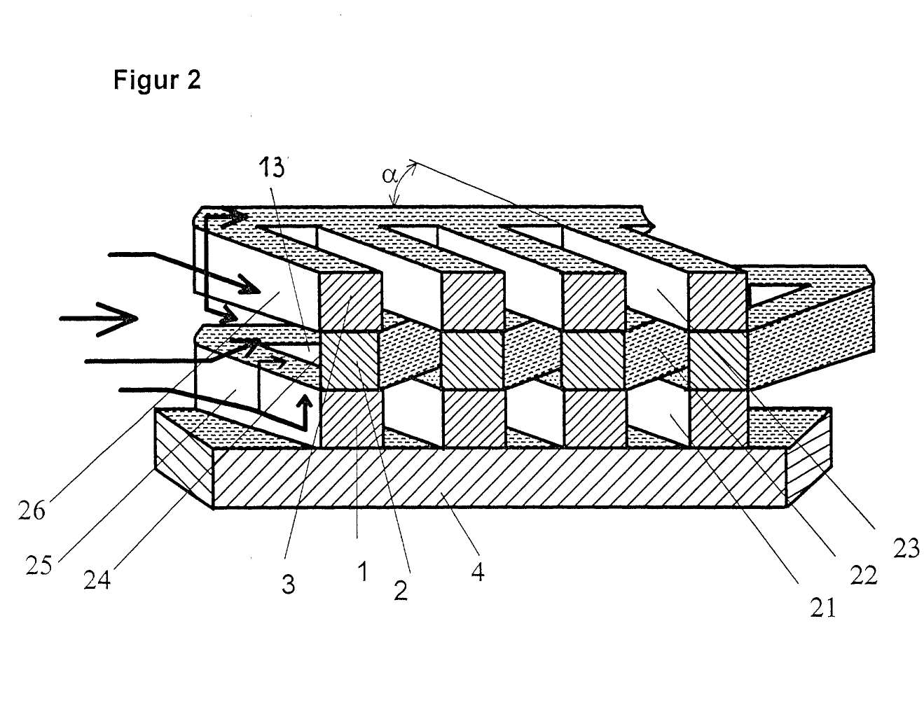

FIG. 2 shows a segment of a tube reactor as depicted in FIG. 1 without upper covering layer. Webs between the openings at the angle α can be seen; these produce a mixing action.

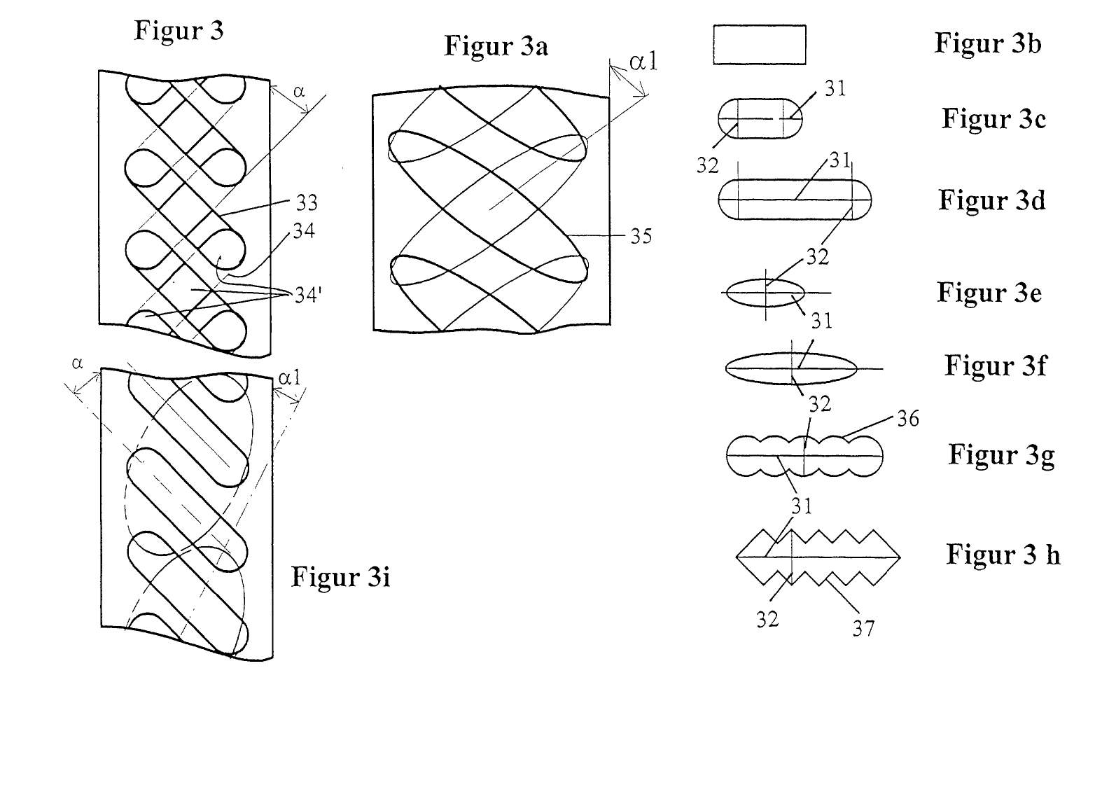

FIGS. 3, 3a, 3i show preferred elongated geometric shapes of openings in two superposed layers, with the openings being inclined at an angle α to the flow direction and intersecting regions being visible.

FIGS. 3b-3h show various cross-sectional shapes of openings.

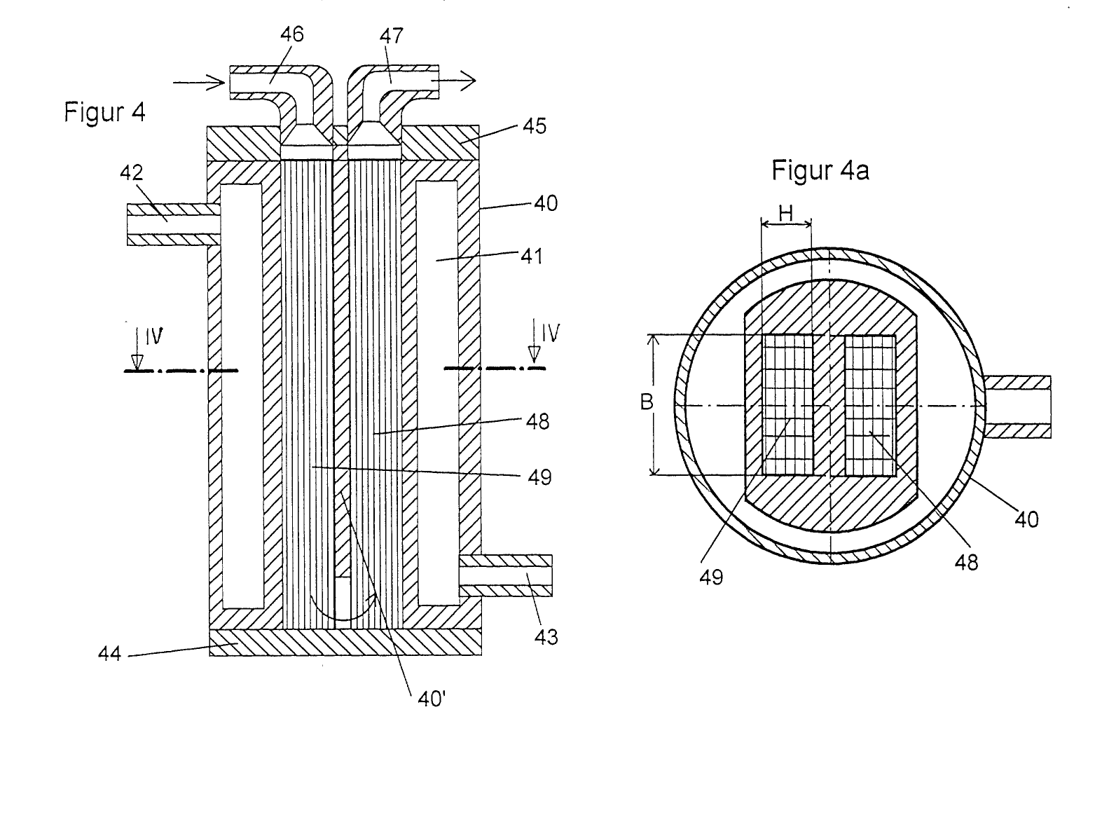

FIGS. 4, 4a show a heatable/coolable housing into which two laminates have been inserted, with the two laminates being separated from one another by a shortened covering layer so that material flows through them in succession. FIG. 4a depicts a cross section of the housing in which the two laminates are present along line IV-IV in FIG. 4.

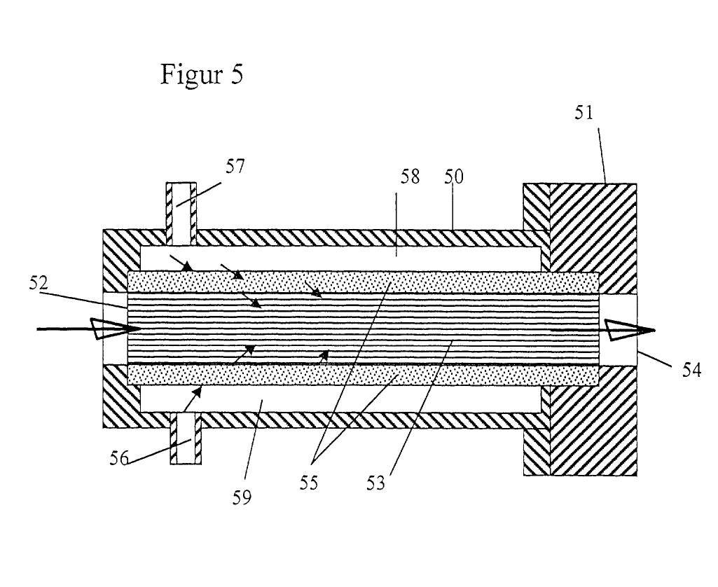

FIG. 5 shows a laminate having a porous covering layer parallel to the laminate and surrounded by a pressuretight housing with feed lines and hollow spaces.

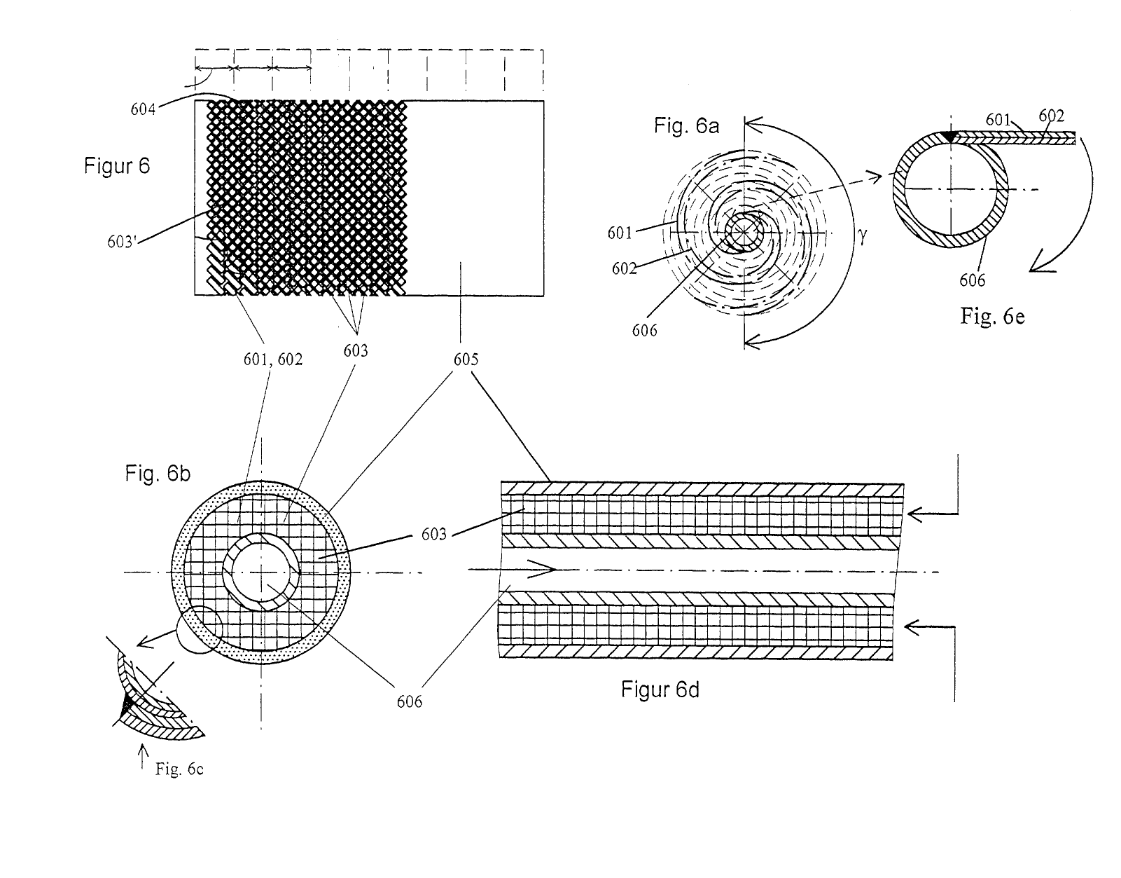

FIG. 6 shows two superposed layers having parallel rows of openings, with the number of parallel rows of openings being such that the length of perforated layer perpendicular to the rows is a number of times the circumference of a cylindrical core or tube and the parallel rows of openings are joined at the side by a nonstructured region which likewise has a width of at least twice the circumference of the core.

FIG. 6a shows a section through a tube reactor in which two layers as depicted in FIG. 6 are fastened in a spiral shape around a cylindrical tube and are tightly wound around it until the layers form a concentric flow channel and an outer wall surrounding the channel. Two pairs of thin layers are simultaneously rolled around the core in such a way that they are offset by the angle γ.

FIG. 6b shows a schematic cross section through a tube reactor having an approximately concentric flow channel.

FIG. 6c shows a detail from FIG. 6b to illustrate the soldered point on the covering layer.

FIG. 6d shows a longitudinal section of part of the reactor of FIG. 6b.

FIG. 6e shows a schematic cross section to illustrate the winding technique.

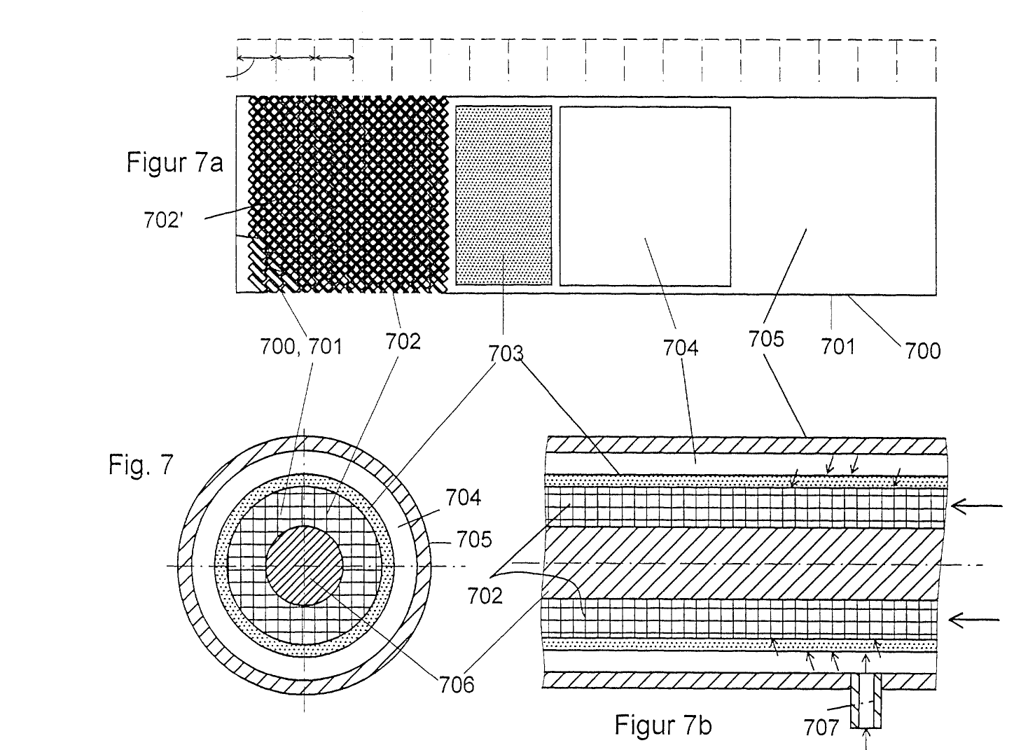

FIG. 7 shows a particular embodiment of an approximately concentric tube reactor based on a spirally wound laminate, with the concentric flow channel being surrounded by a porous covering layer which is in turn surrounded by a distributing pressurized feed space which is closed in a pressuretight manner.

FIG. 7a shows two superposed structured sheets for producing the reactor of FIG. 7.

FIG. 7b shows a longitudinal section of part of the reactor of FIG. 7.

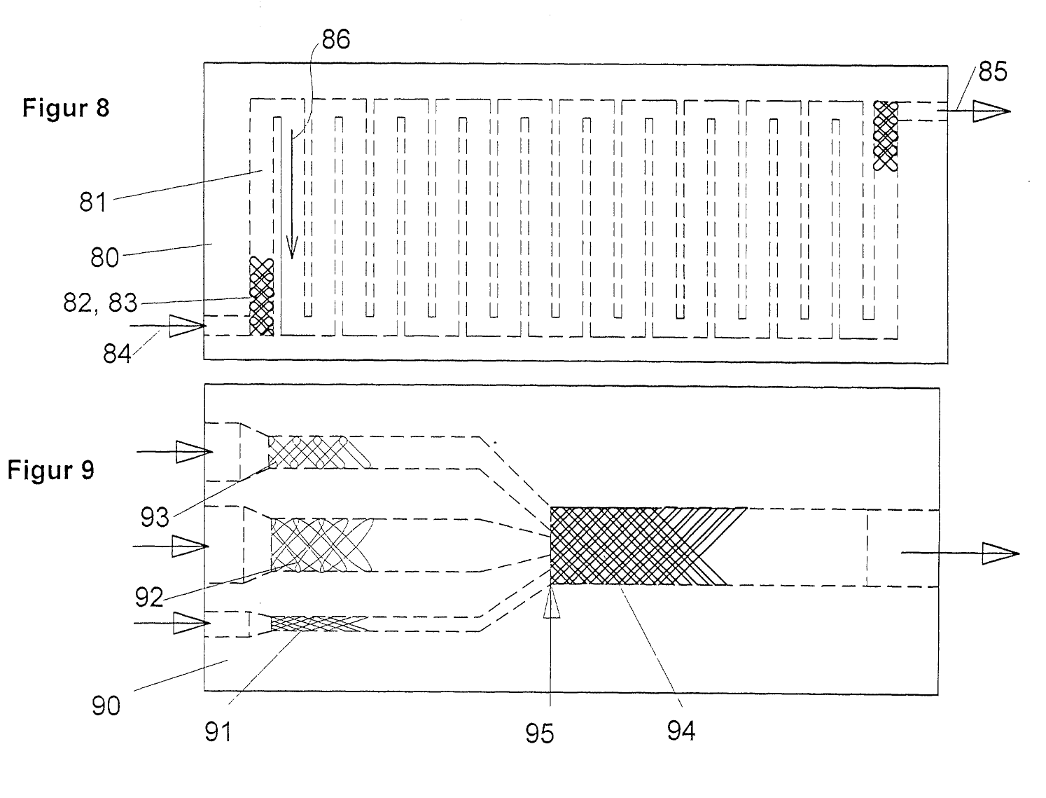

FIG. 8 shows a tube reactor made up of large metal plates which have a circuitous row of openings.

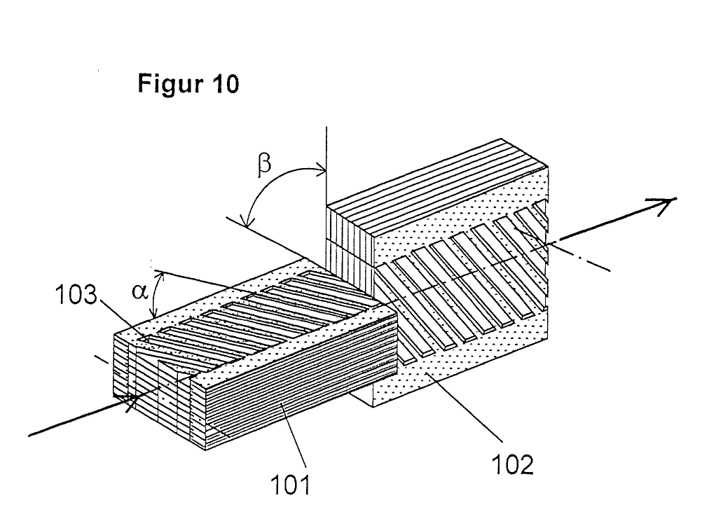

FIG. 9 shows a tube reactor which can be used for a chemical engineering process and in which three separate and different flow channels are connected to a collecting main channel.

FIG. 10 shows a series arrangement of two tube reactors without covering layer which form an angle β to one another in the rotational direction around the axis defined by the main direction of flow.

### EXAMPLES

### Example 1

FIG. 1 shows a side view of the in-principle structure of a tube reactor based on a laminate, with the structured layers 1, 2, 3 and covering layers 4, 5 being shown partly cut away. The overall contour of the laminate shown in section is indicated by a supplementary broken line.

FIG. 1a shows the partly cut-away reactor of FIG. 1 from the top. It is possible to see the lower covering layer 4 and two structured layers 1, 2 which have a thickness of 0.2 mm and are made of stainless steel, with the structured layer 3 being hidden under the covering layer 5. The structured layer 1 displays a row of identical openings (slots) 6 which are inclined at an angle α of 45° to the main direction of flow (arrow). The structured layer 2 is constructed like layer 1 but is turned through 180° and placed on layer 1 so that the openings 7 are at an angle α of −45° and form an intersection region 11 with the respective adjoining openings 6. The structured layers 1, 2 and the hidden layer 3 have a closed edge region 8, 9. The reactor is open at the front side 12 and on its reverse side.

FIG. 1b shows a cross section along line A-A from FIG. 1a. The structured layers 1, 2, 3 and the upper covering layer 5 and the lower covering layer 4 can be seen. The openings of the structured layers, which are superposed and form intersection regions 11, can clearly be seen in the layer structure. At the sides, the closed marginal regions 8, 9, 10 which are welded together to form a pressuretight flow channel 13 can be seen.

FIG. 2 shows a perspective view of part of a tube reactor similar to FIG. 1 with a flow channel 13 and based on a laminate comprising the layers 1, 2, 3 which are structured by openings and in contact and the lower covering layer 4. It can be seen that the openings 21, 22, 23 in the layers partly intersect and the webs 24, 25, 26 between the openings are at the angle α which aids transverse flow, so that intersecting regions and transverse webs ensure good mixing when a material flows through the channel 13.

### Example 2

FIG. 3 shows two superposed layers for a tube reactor which each have openings 33 (FIG. 3d) which are arranged in a row and are elongated in the direction of their transverse axis 31 and have a geometric ratio of width 31 to height (32) of >1. The cross-sectional shape 33 corresponds to the contour of a slot (FIG. 3d), with the openings being inclined at an angle α to the flow direction. Three intersection regions 34′, for example, of similar openings 33, 34 in the two layers can be seen. The tube reactor is provided with at least one further layer which is identical to the bottommost layer and also two covering layers.

The layers of FIG. 3a are built up similarly to FIG. 3, but the openings have an elliptical shape 35 corresponding to FIG. 3f.

FIGS. 3b-3h show further shapes of elongated openings whose major dimension 31 is always greater than the dimension in the transverse direction 32. Furthermore, cross sections of openings having a broken internal contour 36 (FIG. 3g) or zig-zag internal contour 37 (FIG. 3h) are shown.

FIG. 3i shows a combination of two superposed layers having differently shaped openings which at the same time have a different angles α, α¹ to the row within which they are arranged.

### Example 3

FIG. 4 shows a housing 40 for a tube reactor which has a concentric temperature-control jacket 41 and a feed line 42 and a discharge line 43 for the heat transfer medium. The housing additionally has a closing head 44 and a further head 45 which has an inlet 46 and an outlet 47. The heads are joined to the housing 40 by means of screws (not shown). The housing 40 has in its centre two hollow spaces into which two structured packets 48, 49 of layers have been inserted. The two packets 48, 49 of layers are separated from one another by a central dividing wall 40′ which is part of the housing and is somewhat shorter than the inserted structured packet of layers itself, so that it is possible for material to flow sequentially through the laminates. The dividing wall 40′ forms a shared covering layer for the adjoining packets 48, 49 of layers. The packets 48, 49 of layers are each made up of nine structured metal sheets stacked on top of one another in a manner similar to that shown in FIG. 1 and are soldered to one another. The starting materials for the reaction enter at the inlet 46, flow through the flow channel of the packet 49, flow through the gap into the packet 48, travel through this and leave the reactor at the outlet 47.

In FIG. 4a, the housing 40 of FIG. 4 is shown in cross section along the line IV-IV, so that the two inserted laminates 48, 49 and the dividing wall of the housing 40′ between the laminates can be seen.

### Example 4

FIG. 5 shows a tube reactor based on a laminate which can likewise be inserted into a housing 50, which is closed with head 51. The housing has an inlet 52 through which a liquid or gaseous material can flow and enter the packet of layers 53. The product outlet from the packet of layers 53 opens into the outlet 54 through head 51. The packet of layers comprises 12 metal sheets which are structured similarly to the metal sheets shown in FIG. 1 and are soldered to one another in an alternating arrangement. In the embodiment shown, the packet of layers constituting the laminate has, on both sides, a porous covering layer 55 which in one variant can be a membrane and through which a further liquid or gaseous component can be introduced into the stream flowing through the laminate. The gaseous or liquid component is fed via the feed lines 56, 57 into the distribution chambers 58, 59 so that it then passes through the porous layer and flows uniformly over the length through the openings of the outer layers of the packet of layers and into the flow channels of the laminate.

### Example 5

FIG. 6 shows the construction of a structured layer for forming a tube reactor having an approximately concentric cross section. Two structured layers 601, 602 having parallel rows of openings 603 can be seen in FIG. 6. The layers are made of stainless steel sheet and are very thin (0.2 mm) so that they can easily be rolled up. The parallel rows of openings include a section 604 which corresponds to a multiple of a circular circumference. The parallel rows of openings are adjoined by a nonstructured region 605 as a lateral extension. The two superposed layers are made of identically shaped metal sheets which have been turned through 180° relative to one another, so that the openings in the row of one layer intersect with the openings of the adjacent layer.

FIG. 6a schematically shows the principle of forming a concentric flow region. If two structured layers 601, 602 are affixed to a tube 606 (for detail, see FIG. 6e), the free end of the two sheets can be wound in a spiral manner around the tube 606 until all surfaces of the layers are in contact with one another in a manner similar to a fully wound spiral spring.

In a form not shown, a plurality of pairs of layers can be offset by an angle γ which is less than 180° and wound around a cylinder according to the same principle.

As a result of the spiral-like rolling-up, the nonstructured region 605 completely encloses the structured region of the layer, so that the end of the rolled-up metal sheet (see FIG. 6c) can be welded longitudinally to the direction of winding to form a pressuretight flow channel.

The fully rolled up tube reactor can be seen in cross section in FIG. 6b. From the inside to the outside, it is built up as follows: in the centre there is a tube 606 around which structured layers 601, 602 having parallel rows of openings 603 are tightly wound in a spiral fashion to form a concentric flow cross section which is in turn surrounded by the spirally wound nonstructured region (covering layer 605) of the individual layers 601, 602. The edges of the nonstructured layers are welded to themselves at the outer circumference, for example as shown in FIG. 6c.

FIG. 6d shows a longitudinal section parallel to the main flow direction of part of the tube reactor having a concentric flow cross section. The core in the form of a tube 606 can be utilized to heat or cool the flow region by means of a heat transfer medium flowing through it. Around the core tube, there is the concentric flow region formed by the spirally wound parallel rows of openings 603. The concentric flow region is closed by the welded, nonstructured region 605 of the layers, as shown in FIG. 6c.

### Example 6

FIG. 7a shows two superposed layers (metal sheets) 700, 701 having the same structure. However, the layers are extended in their width by a multiple of a circumference, so that in the extension a porous opening region 703 adjoins the parallel rows of openings 702. This is adjoined by a fully open region 704 and in a further extension there is a nonstructured layer region 705. This layer shows by way of example that foils or metal sheets can be variously structured to meet the requirements of different tasks.

If, as shown in FIG. 7, a layer which is specially structured in segments is tightly wound in a spiral around a core rod, as explained previously in Example 5 with reference to FIG. 6, a tube reactor having an approximately concentric process region is formed. In this example, the following process regions are obtained. The process regions are listed from the centre outwards. In the centre, there is the core 706 which can also be a tube and is surrounded by the concentric flow cross section formed by the parallel rows of openings 702, around the concentric flow region there is a thin porous ring formed by rolling up of the special opening region 703, this is adjoined by a concentric hollow space 704 formed by the flat, open region 704 and this is in turn closed by the nonstructured region 705. If the entire metal sheet is coated with solder prior to the rolling up process, the spirally structured apparatus can be soldered so as to be pressuretight.

FIG. 7b shows a longitudinal section through the rolled-up tube reactor. A feed capillary 707 can be installed subsequently to introduce a liquid or gaseous substance into the hollow space 704 so that it can travel from there through the porous layer 703 into the concentric main flow region 702.

### Example 7

FIG. 8 shows a long tube reactor based on a laminate 80 in which the row of openings 81 is arranged in meandering (looped) form in the large-area metal sheet. It can be seen that a plurality of identically structured metal sheets 82, 83 are laid on top of one another, in each case rotated by 180°, so that the openings in the rows intersect and the webs between the openings are at an angle so that radial flow is aided. The long flow channel has a constant flow cross section and a feed opening 84 and a discharge opening 85. The laminate has covering layers, but these are not shown in FIG. 8.

### Example 8

In FIG. 9, a flow channel system 90 based on a laminate having three separate flow channels 91, 92, 93 which have different flow cross sections and different contours of the openings in the rows is shown. The three separate channels make it possible for the individual components fed in to be, for example, individually heated/cooled before they go into a common collecting channel 94 (inlet point 95). The collecting channel 94 can be configured specifically for reactions. The flow channel system 90 makes it possible for a reaction to be commenced at an increased temperature level, with a heating phase of the participating reaction components in separate heatable feed channels having no influence on the reaction.

### Example 9

FIG. 10 shows a reactor system comprising two tube reactors in which two packets of layers 101, 102 each having nine structured layers are connected in series. The two packets of layers 101, 102 are, in a manner similar to the example shown in FIG. 1, provided with a row of elongated openings 103 which are inclined by the angle α to the main direction of flow. The two laminates are rotated relative to one another by the angle β=90°. The packets of layers 101, 102 are pushed into a housing (not shown) which forms the covering layers for the packets of layers and provides for the introduction and discharge of process materials.

### Example 10

### Chemical Reaction in the Tube Reactor

A chemical reaction was carried out continuously in a miniaturized test apparatus in which a heat exchanger and a tube reactor based on a laminate were used. The reaction should be complete after a short reaction time without undesirable by-product being formed. A homogeneous liquid-phase oxidation of the organic sulphide phenylthioacetonitrile to the corresponding sulphoxide using dimethyldioxirane (DMDO) as oxidant was examined. The main problem in a conventional batch reaction is the considerable proportion of sulphone by-product formed from the initially produced sulphoxide by overoxidation after backmixing. It should also be noted that DMDO is an unstable oxidant which cannot be stored and has to be generated immediately before use in the oxidation reaction.

This reaction is described by the following net reaction equation:

C₆H₅—S—CH₂—CN+CH₃—CO₂—CH₃→C₆H₅—SO—CH₂—CN+CH₃—CO—CH₃

To supply the miniaturized tube reactor continuously with feed, 2.25 g of phenylthioacetonitrile made up to 150 ml with 1,2-dichloroethane (0.1 N solution) were placed at 20° C. in a reservoir. A freshly prepared 0.1 N solution of dimethyldioxirane in acetone was present in a second feed vessel, likewise at 20° C. The sulphide was pumped into the tube reactor (preheated to 40° C.) by means of a double piston pump (flow=1.0 ml/min). Preheating was carried out in a heat exchanger based on a plug-in packet of layers. The heat exchanger comprised a tube housing with heatable/coolable jacket similar to that shown in FIG. 4 but equipped with only one packet of layers and an outlet at the lower end of the tube housing. In its centre along the housing axis, the tube housing had only one rectangular opening of 6×6 mm in which a structured packet of layers (48) consisting of 30×0.2 mm thick layers (steel sheet) was installed. The individual layers had a width of 6 mm and a length of 99 mm. The long axis 31 of the openings (FIG. 3) in the layers was at an angle α of 45° to the main direction of flow. The geometric dimensions of the openings (FIG. 3d) were length 31=about 5.4 mm, width 32=0.81 mm and web width=0.25 mm, so that a row of 66 openings was formed.

The reaction apparatus was a tube reactor based on a laminate having an about 2 m long meandering row of openings, similar to the reactor depicted in FIG. 8. The laminate comprised 3 individual structured layers each having a thickness of 0.5 mm and a bottom covering layer and a top covering layer. All layers were soldered to one another over their entire area to ensure good temperature control of the tube reactor. In addition, a heating layer consisting of a metal sheet with a simple flow channel for the heat transfer medium was soldered directly onto the upper covering layer and a further covering layer to close off the heating channel was soldered onto this. The lower covering layer had a feed point 84 for the preheated organic sulphide phenylthioacetonitrile, a second feed point (not shown in FIG. 8) for the second reaction component (DMDO) which was positioned about 100 mm downstream of the feed point 84, a discharge line 85 at the end of the row of openings in the tube reactor to enable the desired reaction product sulphoxide to be collected in a product container and a number of temperature measurement points which are distributed uniformly over the total length of the tube reactor. The openings in the row of holes in the individual layer had the following dimensions: a length 31 of about 10 mm and a width 32 of about 1.6 mm. The openings were at an angle α of 45° to the flow direction. The web width between the openings was 0.5 mm. On the basis of the dimensions of the openings and the height of the laminate, the flow cross section had a ratio of width to height of W/H about 5.

The two feed points which were positioned about 100 mm apart in the direction of flow gave a residence time of about 1.5 min for the organic sulphide phenylthioacetonitrile before the DMDO was pumped into the tube reactor via the second feed point in order to start the reaction. The DMDO was pumped into the tube reactor by means of a second double piston pump (flow=1.0 ml/min) likewise with low pulsation. The remaining residence time of the reaction mixture in the tube reactor was about 8 min, which corresponds to a reactor length of about 1.9 m. At the exit point 85, the reaction mixture was collected in a product receiver and prepared for analysis.

By means of this procedure, complete oxidation of the sulphide to the sulphoxide was able to be achieved in the tube reactor based on a laminate. Owing to the way in which the reactor is constructed out of the structured layers, mixing with little backmixing occurs during passage through the tube reactor, so that no backmixing occurs during the reaction in the tube reactor but the reaction components are mixed so well that no overoxidation by-product (sulphone) is formed.

### Example 11

In a series of experiments, the heat exchange performance of a tube reactor based on a laminate was compared with a comparable conventional tube heat exchanger (Liebig tube).

Description of the Apparatuses

The tube reactor based on a laminate (similar to FIG. 1) comprised a 99 mm long flow channel built up of a laminate packet 1, 2, 3 closed off by two 0.5 mm thick covering sheets 4, 5 which were welded onto the laminate packet. The laminate packet was made up of 20×0.1 mm thick layers (steel sheet). The individual layers had a width of 6 mm and a length of 99 mm. The long axis of the openings 6 in the layers was at an angle α of 45° to the main direction of flow. The geometric dimensions of the openings (FIG. 3d) were length 31=about 5.4 mm, width 32=0.81 mm and web width=0.25 mm, so that a row of 66 openings was formed. The packet of layers had a flow channel cross section ratio W/H of about 1.9. The flow channel described was encased in a tube 40 of φ12×1.5 mm outside diameter 12 mm, wall trickness 1.5 mm in a manner similar to that shown in FIG. 4 and provided with connections 42, 43 for heat transfer medium.

The comparative heat exchanger comprised a 99 mm long flow channel (φ4×0.5 mm tube) without internals which was enclosed by an identical jacketing tube to that used for the tube reactor. The inside tube was dimensioned so that the flow channel cross section and the wall thickness corresponded to those of the abovementioned tube reactor.

Both apparatuses were made of stainless steel.

| | Tube reactor according | | |
|---|---|---|---|
| | to the invention | | Liebig tube |
| Length of flow channel | mm | 99 | 99 |
| Flow cross section | mm² | 7.6 | 7.1 |
| Wall thickness | mm | 0.5 | 0.5 |
| Fill volume | ml | 0.53 | 0.7 |
| Wetted surface area | mm² | 4000 | 930 |

Description of the Experimental Arrangement

Both apparatuses were tested under identical conditions. A stream of liquid having a temperature of about 20-25° C. was passed through the flow channel at a constant flow velocity (0.4 m/s in the case of water and 0.1 m/s in the case of glycerol) and heated by passing hot water (60° C. and 90° C.) through the jacket in countercurrent.

Experimental Results

Water (η = about 1 mPa · s)

| | | Tube reactor | | | |
|---|---|---|---|---|---|
| | | according to the | | | |
| | | invention | | Liebig tube | |
| Temperature of heating | ° C. | 60 | 90 | 60 | 90 |
| medium | | | | | |
| Mean heat transfer coefficient | W/m²/K | 6000 | 7000 | 3600 | 4500 |

Glycerol (η = about 1000 mPa · s at 24° C.)

| | | Tube reactor | | | |
|---|---|---|---|---|---|
| | | according to the | | | |
| | | invention | | Liebig tube | |
| Temperature of heating | ° C. | 60 | 90 | 60 | 90 |
| medium | | | | | |
| Mean heat transfer coefficient | W/m²/K | 2300 | 2500 | 400 | 450 |

Discussion of Results

The performance can be most appropriately compared by way of the mean heat transfer coefficient (k value). Part of the observed improvement in performance can be attributed to the flattening of the flow cross section with the W/H ratio of 1.9, but the major part is due to the mixing action of the laminate. Firstly, the energy is introduced more effectively into the liquid volume because of the better heat conduction of the metallic laminate, and, secondly, the mixing structure of the laminate produces forced convection and thus improved heat transfer.

The difference in performance increases disproportionately with increasing viscosity of the medium.

### Example 12

### Mixing in a Tube Reactor with Laminar Flow

In an experiment, the mixing action in the case of laminar flow in a tube reactor based on a packet of layers constructed in a fashion similar to that shown at right in FIG. 10 was compared with a heat exchanger according to the prior art. For this purpose, an about 100 mm long tube reactor comprising 20 perforated layers (steel sheet) was installed in a transparent polycarbonate housing. The openings in the layers had a geometry as shown in FIG. 3d and had identical dimensions. The dimensions chosen were: length=5 mm, width=0.8 mm and web width between the openings=0.25 mm.

The mixing flow cross section was made up of 20 superposed 0.2 mm thick metal sheets, so that a flow cross section of about 4×4 mm was always obtained. The feed and discharge channels in the polycarbonate housing each had a square cross section of 6×6 mm.

The layer structure constructed as described in the patent application WO 98/55812 was produced with 19 successive openings in each of four rows in a layer, so that each individual layer had 76 openings. These openings located next to one another in the layers had their long axis elongated parallel to the main direction of flow. The opening (slot) of one layer in each case overlapped a maximum of two openings of an adjacent layer. The overlap of the openings in alternate layers produced four flow channels running right through the laminate. To enable mixing over the total flow cross section (four openings next to one another), the four parallel openings were in each case joined by a cut-out (0.25 mm wide and 0.1 mm high) in the 0.25 mm wide separating webs.

An individual layer of the reactor according to the invention (as depicted at right in FIG. 10) had 66 openings whose long axis was at an angle α of 45° to the line formed by the rows within they were arranged. The individual layers had an identical structure except that their long axis was in each case turned through 180° relative to the neighbouring layers and the layers were arranged on top of one another in this way.

Experimental Procedure

As mixing task in the tube reactor, two streams having different volume flows were to be mixed homogeneously. The substance chosen was silicone oil having a viscosity of 10 Pa·s. The first stream was transparent and the second stream was dyed black so that the mixing performance of the laminates could be assessed visually through the transparent plastic housing. The total mass flow was about 1.4 g/min and a pressure drop of about 3.2 bar was established.

Result

The heat exchanger as described in the patent application WO 98/55812 displayed no mixing action in the plane of the layers and only a slight mixing action in the direction of stacking. It could clearly be seen that the perforated layers having parallel openings form four individual channels and the individual channels display no crossmixing, despite the fact that lateral connecting channels between the individual channels are present.

In the case of the reactor according to the invention, on the other hand, complete mixing in the plane of the layers and good mixing in the direction of stacking were observed, even though the number of openings in an individual layer was significantly less than in the comparative apparatus.

Discussion

Compared with the heat exchanger of the prior art (WO 98/55812), single-channel flow is achieved in the tube reactor of the invention. Distribution problems in the case of streams having different flows and differing density and viscosity do not occur: quick and good mixing always occurs, which significantly improves the effectiveness and function of the reactor and, in particular, the mass transfer.

A critical factor in the high performance of the reactor is the openings present in the flow region which are at an angle α and generate transverse flow by means of their walls.

Owing to its lack of mixing action, the heat exchanger described in WO 98/55812 cannot be used as reactor.

We claim:

1. A tube reactor comprised of a laminate of at least three structured layers, which structured layers have a longitudinal direction and a transverse direction and together form a laminate having a longitudinal direction and a transverse direction, one of said at least three structured layers being a top structured layer and one being a bottom structured layer, and the remainder of said at least three structured layers being one or more middle structured layers between said top structured layer and said bottom structured layer, said top structured layer being covered by a first covering layer and said bottom structured layer being covered by a second covering layer, the structured layers each having a plurality of openings passing through them to the adjacent layers, said plurality of openings in each structured layer being arranged in at least one longitudinal row, the openings in each of said at least one longitudinal row of openings being sequential to each other, said openings being elongated in a direction transverse to the direction of the longitudinal rows within which they are arranged, wherein individual openings in a middle layer overlap and communicate with at least three openings in an adjacent layer, whereby at least one channel is formed through said laminate.

2. The reactor of claim 1, wherein said at least one channel is oriented in the longitudinal or transverse direction of said laminate.

3. Tube reactor according to claim 1, wherein the openings in succeeding structured layers are arranged in periodically recurring orientations.

4. Tube reactor according to claim 2, wherein said at least one channel is oriented in the longitudinal direction of the laminate, and is structured to prevent backmixing of fluids which pass through it.

5. Tube reactor according to claim 2, wherein said openings have an elongated geometric shape, and wherein the axis of the elongated direction of the openings is at an angle α of from 5° to 85° to the direction of the rows within which they are arranged.

6. Tube reactor according to claim 1, wherein said openings are arranged in a nested row so that, when viewed in the longitudinal direction of the row of openings, openings of adjacent layers are arranged next to one another over at least part of their length.

7. The tube reactor of claim 1, wherein said openings are rectangular or elliptical in shape.

8. The tube reactor of claim 1, wherein the openings of adjacent layers have intersection ratios of from 1.5 to 10.

9. The tube reactor of claim 8, wherein said intersection ratios are from 2.5 to 7.5.

10. The tube reactor of claim 1, wherein the inside walls of the openings have a zig-zag shape.

11. The tube reactor of claim 1, wherein the number of openings in each structured layer is at least 50.

12. The tube reactor of claim 11, wherein said number of openings is at least 200.

13. The tube reactor of claim 12, wherein said number of openings is at least 500.

14. The tube reactor of claim 1, wherein said at least one flow channel has an L/D ratio of greater than 10.

15. The tube reactor of claim 14, wherein said L/D ratio is greater than 100.

16. The tube reactor of claim 15, wherein said L/D ratio is greater than 500.

17. The tube reactor of claim 1, further comprising a second said laminate, the two laminates being arranged in series and the layers of one laminate being rotated by an angle β of from 30° to 90° relative to the planes of each other.

18. The tube reactor of claim 1, wherein the layers are made of a material selected from the group consisting of metal, plastic, glass and ceramic.

19. The tube reactor of claim 18, wherein said material is metal, and said metal is aluminium or steel.

20. The tube reactor of claim 1, wherein the inside walls of the openings in said structured layers, covering layers, or any combination thereof, are coated with a catalyst, or the structured layers are constructed of a catalytic material.

21. The tube reactor of claim 1, wherein said structured layers are configured as a packet adapted to be inserted into a housing, which housing forms the covering layers.

22. The tube reactor of claim 1, wherein said covering layers are, independently of each other, configured at least in part as mass transfer membranes.

23. The tube reactor of claim 1, wherein the cross section of the channel has a ratio of width to height of greater than 1.

24. The tube reactor of claim 23, wherein said ratio is greater than 2.5.

25. The tube reactor of claim 24, wherein said ratio is greater than 5.

26. The tube reactor of claim 1, wherein the successive laminates have hydraulic cross sections of differing differing magnitudes.

27. The tube reactor of claim 1, wherein the reactor has a meandering channel in the planes of the structured layers.

28. The tube reactor of claim 1, wherein the reactor has at least one branching point at which two individual channels are connected to a third channel.

29. A tube reactor comprised of a laminate of at least two structured layers, which are wound around a core tube or rod, and a covering layer arranged on the outer circumference of the wound structured layers, the structured layers each having a plurality of openings arranged in at least one row, the openings in each of said at least one longitudinal row of openings being sequential to each other, said openings being elongated in a direction transverse to the direction of the rows within which they are arranged, wherein individual openings in one layer overlap and communicate with openings in an adjacent layer, whereby at least one channel is formed through said laminate.

30. The tube reactor of claim 29, wherein at least a part of said covering layer is porous, and said tube reactor further comprises a distribution chamber concentric to said covering layer, said distribution chamber having an inlet opening.

31. The tube reactor of claim 29, wherein said at least one channel is defined by surfaces having a catalytic coating, or the structured layers are made of catalytic material.

32. A method of carrying out a chemical reaction, which comprises carrying out said chemical reaction in a reactor of claim 1.

33. A method of carrying out a chemical reaction, which comprises carrying out said chemical reaction in a reactor of claim 29.

34. A method of carrying out a mass transfer process, which comprises carrying out said mass transfer process in a reactor of claim 1.

35. A method of carrying out a mass transfer process, which comprises carrying out said mass transfer process in a reactor of claim 29.

36. A column packing comprising the reactor of claim 1.

37. A column packing comprising the reactor of claim 29.

38. A method for contacting a gas with a catalyst, which comprises passing said gas through the at least one channel of the reactor of claim 20.

39. A method for contacting a gas with a catalyst, which comprises passing said gas through the at least one channel of the reactor of claim 31.
